(19) United States
(12) Patent Application Publication
(10) Pub. No.: US 2003/0076537 A1
(43) Pub. Date: Apr. 24, 2003

(54) Solid state memory device and a method of document reproduction

(76) Inventor: Barry Allen Thomas Brown, Glasgow (GB)

Correspondence Address: HEWLETT-PACKARD COMPANY, Intellectual Property Administration, P.O. Box 272400, Fort Collins, CO, 80527-2400, US

(21) Appl. No.: 10/255,631

(22) Filed: Sep. 27, 2002

(30) Foreign Application Priority Data
Sep. 28, 2001 (GB) 0123473.1

(51) Int. Cl. G06F 3/12; G06F 15/00

(52) U.S. Cl. 358/1.16; 358/1.15

(57) ABSTRACT

A method of associating a digital version of a document with a printed version of the document, the method being executable by a processor and comprising the steps: (a) instructing a printer to print the document; and, substantially at the time of printing, (b) transferring, to a portable solid state memory device, data interpretable by a processor to enable subsequent reprinting of the document. The invention also provides an electronic device electrically couplable to a printer, computer or network, configured to couple with a portable solid state memory device and to receive data corresponding to a print job, and operable to write data to the said solid state memory device, substantially at the time of printing of the said print job, to enable subsequent reprinting of the print job. Also provided is a solid state memory device having an integral clip by which the device may be clipped onto a printed document, the device being operable to store digital data interpretable by a processor to enable subsequent reprinting of the document.

This invention relates to a solid state memory device and a method of document reproduction.

### BACKGROUND TO THE INVENTION

Office workers, research scientists and other professional people routinely deal with a large number of documents, in both electronic and printed formats. Electronic versions of documents can take several formats, with common examples being word processed data files, scanned digital images of the document, and Portable Document Format (PDF) files as supported by Adobe (RTM) Acrobat (RTM). These are typically stored on the hard disk of a workstation or a server.

A common problem, experienced by many, is that it can be difficult or even impossible to locate an electronic version of a document after it has been printed. It is often necessary to find and reopen a word processed document after printing, in order to make amendments to its content or to print additional copies, for example. However, a computer file may become deleted from the disk on which it was stored, or lost on a workstation's hard disk or on a server, or the filename assigned to the document may become forgotten. Search facilities as provided by Microsoft (RTM) Windows (RTM) may assist in finding a lost file, but they can be time consuming to operate and have no way of finding a deleted file or one that is stored on a data storage medium that is not accessible from the user's computer.

Other potential problems currently exist with regard to document copying. If a user is unable to reprint a document from a computer file then it is highly likely that he will use a photocopier to make a copy. However, if only one printed copy of the document exists, then using a photocopier may be risky since they are liable to damage documents. Sheets of paper may become crumpled or torn when passing through an automatic sheet feeder, particularly if the sheets are old or were partly torn beforehand. Additionally, old books can be damaged by forcing open the spine in order to photocopy the contents.

Another problem associated with copying is enforcing copyright ownership against those who make unauthorised copies of printed publications. This problem is particularly experienced by commercial publishers who are very often unable to control or regulate copying by members of the public.

It is a general object of the present invention to overcome or at least mitigate the problems, shortcomings and disadvantages identified above.

### SUMMARY OF THE INVENTION

According to a first aspect of the invention there is provided a method of associating a digital version of a document with a printed version of the document, the method being executable by a processor and comprising the steps: (a) instructing a printer to print the document; and, substantially at the time of printing, (b) transferring, to a portable solid state memory device, data interpretable by a processor to enable subsequent reprinting of the document.

The term ‘document’ is used herein in a broad sense to refer to the printed output of a print job, and should be taken to encompass both textual and graphical output. The portable solid state memory device may be kept with the printed version of the document—for example, clipped to the document or included in its packaging—and advantageously enables high quality copies to be readily printed on a later occasion. These copies can be made without needing to photocopy the original printed document, thereby avoiding the inconvenience associated with photocopying and removing any likelihood of the document being damaged by a photocopier.

Preferably step (b) comprises transferring a digital version of the document to the said portable solid state memory device. This advantageously enables subsequent reprinting of the document to be performed without any need for the actual data file that was used when first printing the document. This safeguards the user against losing or deleting the original data file.

Particularly preferably the format of the digital version of the document is selected from a group comprising: native file format; Printer Control Language; Postscript format; hypertext markup language; Portable Document Format. Native file formats are specific to the application (e.g. a word processor) used to create the document. Using the native file format advantageously enables the document not only to be subsequently reprinted but also edited. Printer Control Language (PCL), Postscript, hypertext markup language (HTML) and Portable Document Format (PDF) may not permit the document to be edited to such an extent, but offer a means of reproducing its content without requiring access to the original application that was used to create it. This is advantageous should the original application become obsolete or be superseded in the workplace, such that it is no longer available for use.

Alternatively, step (b) comprises transferring to the said portable solid state memory device a link to a digital version of the document. The digital version of the document itself is stored elsewhere, such as on a computer's hard disk, a network fileserver or a webserver. The link may take the form of a file ‘shortcut’ or a HTML link to a file stored on a webserver. This advantageously results in reducing the time required to transfer the necessary data to the solid state memory device, since only a short link needs to be written instead of the entirety of the digital version of the document as printed. Furthermore, minimising the memory of the solid state memory device also has the advantage of enabling it to be manufactured compactly and inexpensively.

Preferably the method further comprises the steps of: (c) accessing the said solid state memory device; and (d) reprinting the said document.

Preferably the method further comprises notifying, via a digital communications network, or copyright owner or publisher) of the reprinting performed in step (d). This advantageously provides a means by which a copyright owner (e.g. a publisher) can monitor reproduction of the document, enabling them to seek royalties in respect of licensed copying or to take action against copyright infringers if the copies have been made without the copyright owner's permission.

Preferably the method yet further comprises the copyright owner making a charge for the reprinting performed in step (d). This charge, which may be effected automatically (e.g. via the Internet) advantageously enables the copyright owner or publisher to be compensated for the reproduction of their document (or a part thereof). Since the memory device enables copies to be generated that are of the same quality as the original (although this is dependent on the printer used), the user is thereby encouraged to use this method of copying instead of a photocopier. Given the incentive of being able to obtain a high quality copy of the document, the user is likely to be more willing to pay a fee to the copyright owner than if the copy was simply made using a conventional photocopier.

According to a second aspect of the invention there is provided a solid state memory device having an integral clip by which the device may be clipped onto a printed document, the device being operable to store digital data interpretable by a processor to enable subsequent reprinting of the document. This has the advantage that the device may be kept with the printed document such that, given the document on which the device has been clipped, a user will readily be able to make a copy. A further advantage is that the device can replace conventional paper clips and staples, which is likely to become a highly relevant issue in the future with the advent of reusable paper systems (e.g. “electronic paper”) which will not permit stapling.

According to a third aspect of the invention there is provided an electronic device electrically couplable to a printer, computer or network, configured to couple with a portable solid state memory device and to receive data corresponding to a print job, and operable to write data to the said solid state memory device, substantially at the time of printing of the said print job, to enable subsequent reprinting of the print job. Advantageously this device may be installed in a personal computer (PC), or as a peripheral device connected to a PC or in a network.

Preferably the electronic device is further configured to transfer a digital version of the content of the print job to the said solid state memory device. Particularly preferably the format of the digital version of the content of the print job is selected from a group comprising: the native file format of the content of the print job; Printer Control Language; Postscript format; hypertext markup language; Portable Document Format.

Alternatively, preferably the electronic device is further configured to transfer to the said solid state memory device a link to a digital version of the content of the print job.

Preferably the electronic device is further operable to read data from a portable solid state memory device and enable the printing of a document specified by the said data.

Preferably the electronic device is integral with a printer. This advantageously results in a single piece of equipment operable to write to a memory device at the point of printing, and also to reproduce subsequently a printed document using the memory device, without recourse to photocopying.

Preferably the electronic device has a carousel capable of holding a plurality of portable solid state memory devices and is operable to write to each of the said memory devices in sequence. Particularly in a high-usage environment (e.g. with a network printer) this advantageously enables a single device to write to a separate memory device for each different print job, without a user needing to manually supply a fresh memory device every time.

Preferably the electronic device is further configured to erase or re-use a portable solid state memory device to which data corresponding to a print job has been transferred but which has not been removed from the electronic device within a predetermined time period. This ensures that, if a first user does not collect the memory device that has just been written for them, a second user cannot later take it away and thereby view the document to which it refers, which may be confidential or sensitive in content.

### BRIEF DESCRIPTION OF THE DRAWINGS

Embodiments of the invention will now be described, by way of example, and with reference to the drawings in which:

FIG. 1 illustrates a paperclip having an integral solid state memory device;

FIG. 2 illustrates the paperclip of FIG. 1 reconfigured to enable the solid state memory device to electrically couple with a compatible read/write device;

FIG. 3 illustrates the paperclip of FIG. 1 used to clip printed paper;

FIG. 4 illustrates the read/write device of FIG. 2 connected to a network;

FIG. 5 illustrates the read/write device of FIG. 2 chained to a printer on a network;

FIG. 6 illustrates a printer having an integral read/write device compatible with the aforementioned solid state memory device;

FIG. 7 illustrates a sequence of processing a print job by (i) printing the print job and (ii) transferring a digital version of the print job to a solid state memory device; and

FIG. 8 illustrates a sequence of processing a print job by (i) printing the print job, and (ii) transferring to a solid state memory device a link or reference to a digital version of the print job.

### DETAILED DESCRIPTION OF THE PREFERRED EMBODIMENT

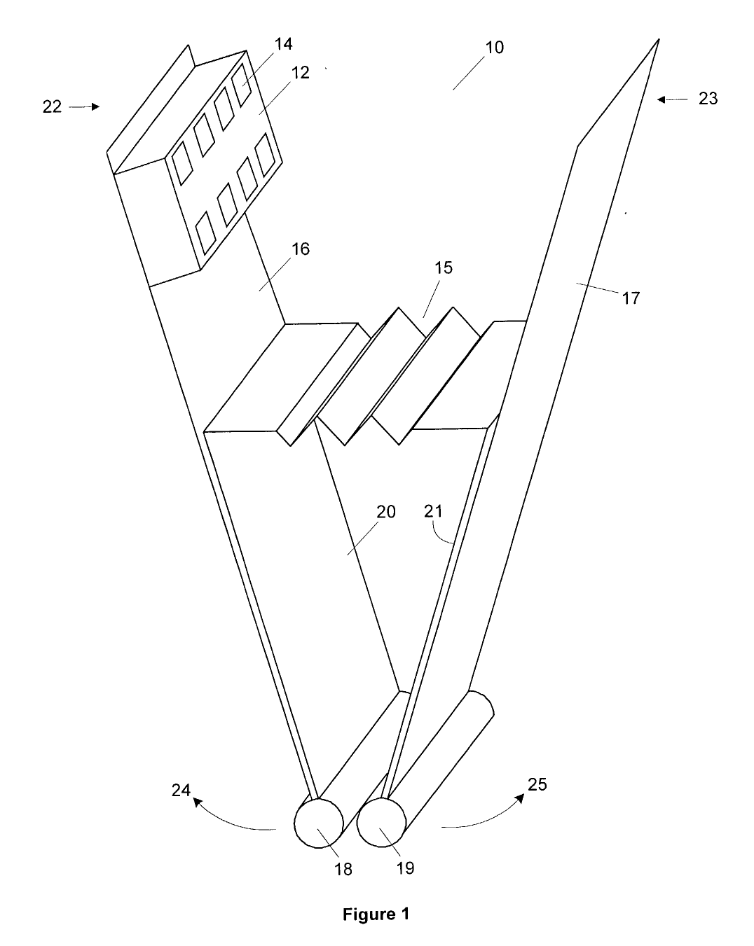

FIG. 1 illustrates a paperclip 10 having an integral solid state memory device 12 which has a plurality of electrical contacts 14. The solid state memory device 12 has the functionality of a smart media module such as a flash card or a memory stick, the construction and operation of which are known to those skilled in the art.

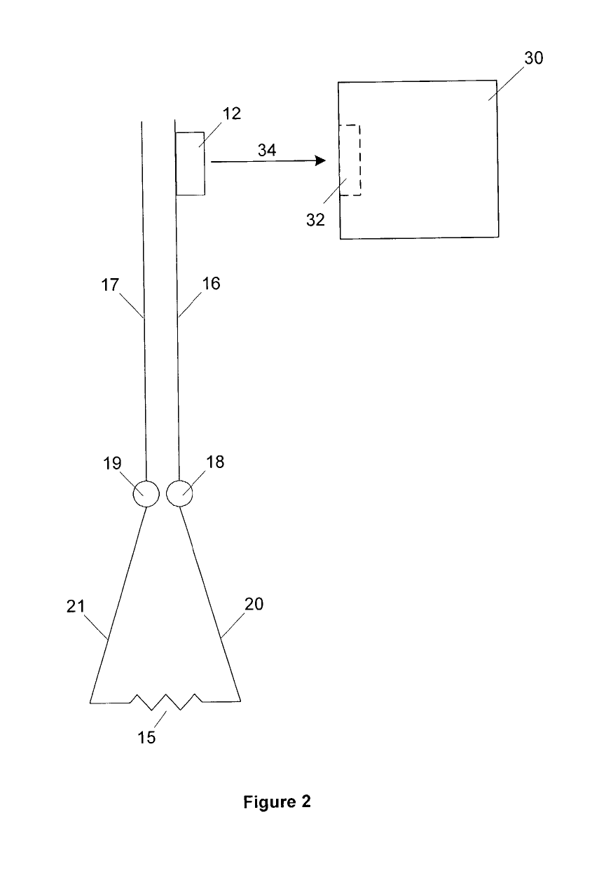

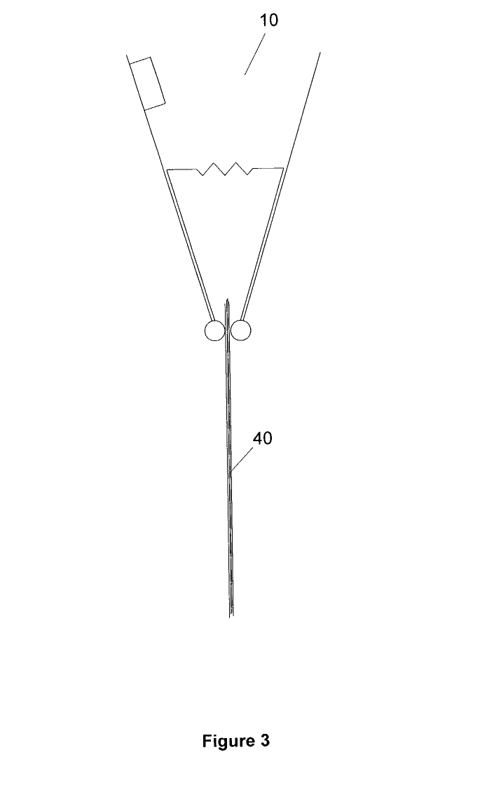

Apart from having this integral solid state memory device 12, in other respects the so-called ‘electronic clip’ resembles a conventional bulldog- or foldback-style clip. The paperclip shown in the Figures is of the latter variety, having a pair of sides 20,21 each terminated by a gripping member 18,19 and joined by a resilient member 15, the resilient member 15 being biased to close together the gripping members 18,19. Arms 16,17 are attached to the gripping members 18,19 and are rotatable outwards about the gripping members 18,19 to enable the paperclip to be manipulated into the configuration shown in FIG. 2. As indicated in FIG. 1, by squeezing together 22,23 the arms 16,17 a user may open out 24,25 the gripping members 18,19 to enable paper to be inserted therebetween. As illustrated in FIG. 3, upon release of the arms the gripping members then close under the action of the resilient member to grip the paper 40. The action of such a paperclip is well known, and it will be appreciated that alternative configurations are possible. One alternative possibility is that the clip may not be adapted to be removably attachable to the paper 40, as for a conventional paperclip, but may instead be permanently attached (in the sense that the clip is not designed for reuse) as for a conventional staple. As the document stored on the clip is related to the paper to which the clip is attached, it is perfectly appropriate to have a permanent attachment of this type.

When the paperclip is folded as shown in FIG. 2 the solid state memory device 12 essentially becomes on the outside of the clip such that its electrical contacts (14 in FIG. 1) are outermost, and in this configuration the memory device 12 can communicatively couple with a read/write peripheral device 30. The peripheral device 30 has a port 32 into which the memory device 12 may be inserted 34 and electrically coupled, thereby enabling digital data transfer to occur between the read/write device 30 and the memory device 12. It will be appreciated that wireless data communication between a solid state memory device and a read/write device is also possible, and the present invention should be taken to encompass both electrical and wireless forms of data communication.

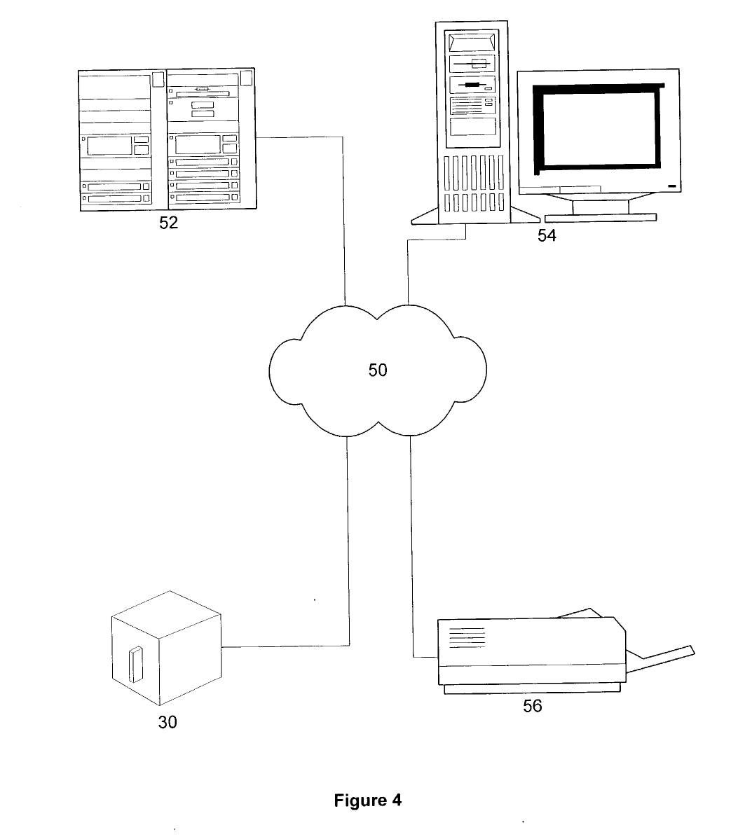

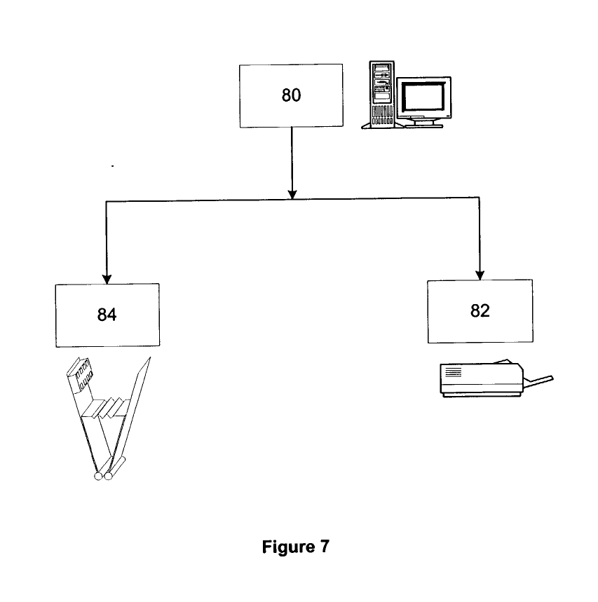

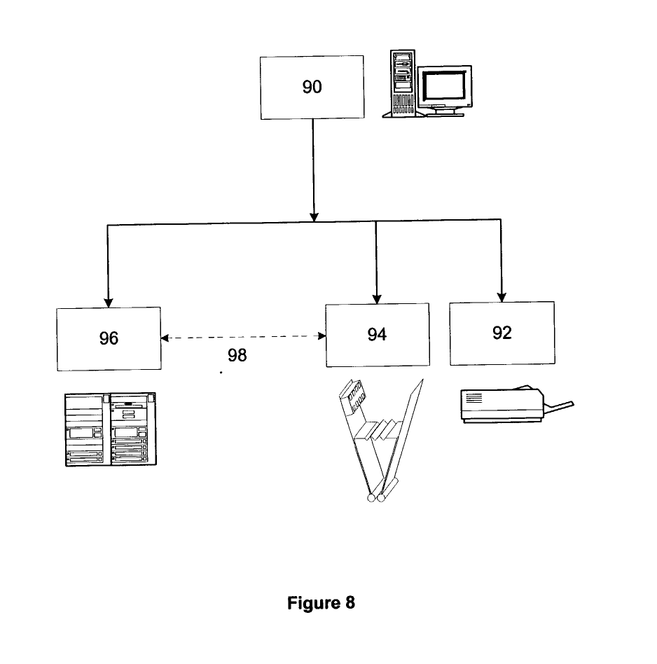

The method of operation of the electronic clip in conjunction with a read/write device will now be described in the context of document printing, copying and publishing, with reference to the network diagrams shown in FIGS. 4 to 6 and the procedural flow diagrams in FIGS. 7 and 8.

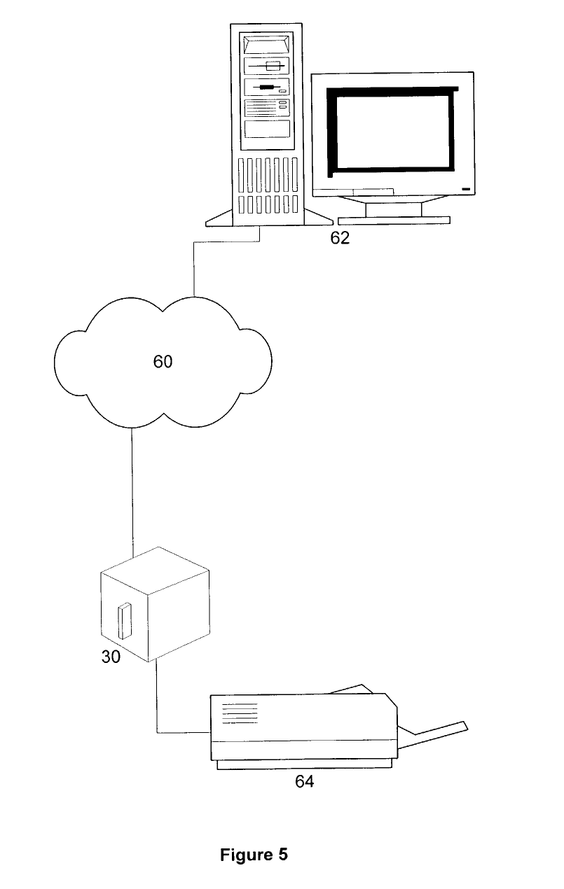

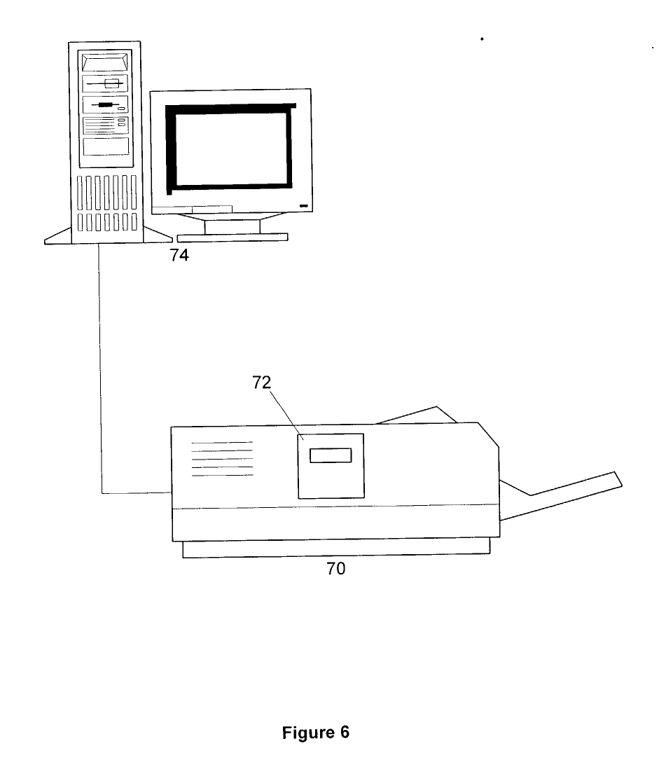

As shown in FIG. 4, a read/write peripheral device 30 may be installed on a network 50 having one or more PCs 54, a printer 56 and optionally a server 52. Alternatively, as shown in FIG. 5, the peripheral device 30 may be connected directly to a printer 64 such that it is chained to the printer's data communications port. Through chaining, the device 30 and the printer 64 are configured such that print data sent to the printer 64 from a PC 62 via a network 60 (or alternatively via a cable connection between the computer and the printer) passes through the device 30 en route to the printer 62. In another possible embodiment as shown in FIG. 6 the read/write device 72 may be integrated in a printer 70, which is shown in this Figure as being directly connected to a PC 74 but which may alternatively be a network printer. Such integration is consistent with existing printer arrangements—it is known for printers (particularly network printers) to have an integral stapling attachment. This could be re-designed to provide clips (or staples) according to aspects of the present invention to bind the document after printing.

In use, an electronic clip is introduced to the read/write device and the solid state memory device is connected in digital communication with the read/write device, thereby enabling data transfer to occur between the read/write device and the memory device. The read/write device is configured such that it is associated with a printer (or optionally more than one printer), and is configured to monitor this printer for print jobs sent to it by one or more connected computers. The computers may be directly connected to the read/write device, or connected via a network.

In one preferred embodiment, on detecting a print job the read/write device captures the content of a print job and transfers it to memory within the read/write device before passing the print job on to the printer for printing. The read/write device then encodes the content of the captured print job into an appropriate format and stores it on the solid state memory device of the electronic clip. By subsequently accessing this stored data from the electronic clip it is thereby possible to reprint additional copies of the print job without the need for recourse to the original document file (e.g. a Microsoft (RTM) Word file). In summary, a digital version of a printed document is stored on the electronic clip at substantially the time of printing the document.

Different formats of print job encoding and storage may be used, according to user preferences:

The content of the print job may be stored on the electronic clip as a raw print data stream, in the format in which it was sent from the computer to the printer. Common formats are PCL and Postscript, although it will be appreciated by those skilled in the art that other formats of printer command languages are possible. Storing print data in such a format has the advantage that it can be directly interpreted by a printer to enable rapid subsequent reprinting of the print job, although it is not readily editable.

Alternatively the read/write device may capture the printed document's native data file (e.g. a Microsoft (RTM) Word file) from the computer at the time of the user issuing the print command. This advantageously enables the document to be subsequently edited as well as printed, but relies on an appropriate version of the software application (e.g. Microsoft (RTM) Word) being available at the subsequent time. However, subsequent reprinting from a specific application is potentially slower than if raw print data (e.g. PCL or Postscript) is used, since, on reprinting, the computer running the specific application will need to regenerate the data stream of commands interpretable by the printer.

A further alternative is for the read/write device to encode the printed document into HTML or PDF format. Regardless of the application originally used to generate the document, these file formats enable the document to be subsequently viewed and reprinted using a web browser (for HTML) or a PDF reader such as Adobe (RTM) Acrobat (RTM).

The embodiment of the invention described above relates to the storage of data on the electronic clip to enable a user to reprint the document entirely from the paperclip, without needing to find or access any data file stored elsewhere. This process is represented schematically in FIG. 7, which illustrates a print job being sent from a computer 80 to a printer 82 and, substantially at the time of printing, also being stored on an electronic clip 84.

In a second preferred embodiment of the invention the print job is captured by the read/write device as described above. The read/write device then sends it on for printing. However, as illustrated schematically in FIG. 8, in this second embodiment a full, self-contained digital version of the printed document is not transferred onto an electronic clip. Instead, when printing a print job, it is sent from a computer 90 to a printer 92 and just a link or a reference to a digital version of the printed document is written to the electronic clip 94. The digital version of the document itself is stored separately 96 from the electronic clip, either on the computer from which it came or on a server (e.g. 52 in FIG. 4) accessible via a network (50 in FIG. 4). The server may be on a local area network or a wider network such as the Internet. The digital version of the document may be stored in any of the formats previously described.

The link or reference to the digital version of the printed document may take a variety of forms, such as a file ‘shortcut’ as used in the Microsoft (RTM) Windows (RTM) operating system, or an ‘alias’ as used in the Apple (RTM) Macintosh (RTM) operating system. Alternatively, particularly for print job content stored on a webserver, the link may be a uniform resource locator (URL) to the required file on a specific server.

It will be appreciated that the portable solid state memory device needs only have a minimal capacity if it only has to store a link or reference to a file, as compared to a complete digital version of the printed document. It may therefore be manufactured relatively inexpensively and compactly.

Since, in this embodiment, the digital version of the document is stored remotely from the electronic clip, it is important to provide adequate security between the clip and the digital document: A public/private key may be calculated at the time of printing, and the public key may then be used to encrypt the data stored on the server. The private key is stored on the electronic clip along with the link. Barcodes could also be used to encode this information, which could be printed on the document on printing, although this would not provide the same level of security as encoding the information on an electronic clip.

Referring now to both the above embodiments, once the document has been printed, the corresponding digital version of the printed document has been prepared and the electronic clip has been written, the clip may then be attached to the printed document. Accordingly, provided the printed document remains secure, then so too will the digital version. Incorporating the solid state memory device in a clip is advantageous since it helps to ensure that the memory device remains with the printed document.

The printed document, with the electronic clip attached, may then be distributed, passed to other people, or held in storage. Whenever a copy of the document is required the electronic clip may be inserted into a read/write device (which may be similar to the one used to write to the clip) and the document reprinted, either by accessing a full digital version of the document stored on the clip, or by accessing a digital version of the document stored on a server via a link (98 in FIG. 8) stored on the clip. Multiple copies may be specified, as may individual pages or sections of a document. This method and apparatus thereby enable a user to copy a document without needing to resort to using a photocopier, and prevent valuable documents from being subjected to the risk of being damaged by photocopying.

The solid state memory device need not be incorporated in a clip, and may conceivably be incorporated in anything in which a microchip may be embedded, such as a folder or a document wallet, for example.

To facilitate reading of the contents of electronic clips a compatible read (or read/write) device may be incorporated in a conventional PC. As mentioned above, a read/write device may also be incorporated in a printer. In large offices and publishing sites the read/write device may also incorporate an automated carousel configured to hold a plurality of electronic clips and to introduce a new one for use, as required, with every print job. In environments such as this, as a security measure each clip may be held in the read/write device for a predetermined period of time (e.g. 5 minutes) before its contents are erased and the clip re-used. This is to make it harder for an unauthorised person to pick up someone else's newly-written clip, take it away and access potentially confidential documents stored therein.

Memory capacity permitting, a single electronic clip may hold digital versions (or links thereto) of a number of different documents. Clip management functions, such as deleting documents or moving them from one clip to another, or onto other data storage devices, are also possible. For example, the same clip may be written on whenever a document is printed that relates to a particular project, thereby enabling all the digital versions of the project's documents to be stored on the same clip. Alternatively, different clips may be used at first but then their contents brought together onto a single clip.

The system described herein has great potential application to publishers of books and journals, in that they may distribute their publications with electronic clips attached. For example, one clip may be supplied with each consignment sent to each local distribution centre or (particularly for academic journals) university library. Anyone then needing to copy the publication, or parts thereof, would then use the electronic clip to make a copy. The copyist will be encouraged to use the clip rather than a photocopier since the quality of copies produced using the clip will be better than photocopies. The device used to read the contents of the electronic clip may be configured to notify the publisher (e.g. via the Internet) that copying is taking place, and to give details of the material being copied. The read/write device being used at the time, or the publisher's computer connected via a network (e.g. the Internet), may then check the copyright status of the publication being copied, determine an appropriate charge in respect of the copies being made, and bill the user as appropriate (which again may be executed via the Internet). The system may be further configured such that the copyist's printer requires authorisation from the publisher's computer before printing may commence, with such authorisation only being given once payment (e.g. via an on-line credit card transaction) has been received.

1. A method of associating a digital version of a document with a printed version of the document, the method being executable by a processor and comprising the steps:
(a) instructing a printer to print the document; and, substantially at the time of printing,
(b) transferring, to a portable solid state memory device, data interpretable by a processor to enable subsequent reprinting of the document.

2. A method as claimed in claim 1 wherein step (b) comprises transferring a digital version of the document to the said portable solid state memory device.

3. A method as claimed in claim 2 wherein the format of the digital version of the document is selected from a group comprising: native file format; Printer Control Language; Postscript format; hypertext markup language; Portable Document Format.

4. A method as claimed in claim 1 wherein step (b) comprises transferring to the said portable solid state memory device a link to a digital version of the document.

5. A method as claimed in claim 1 further comprising the steps of:
(c) accessing the said solid state memory device; and
(d) reprinting the said document.

6. A method as claimed in claim 5 further comprising the step of:
(e) notifying, via a digital communications network, a copyright owner of the reprinting performed in step (d).

7. A method as claimed in claim 6 further comprising the copyright owner making a charge for the reprinting performed in step (d).

8. A solid state memory device having an integral clip by which the device may be clipped onto a printed document, the device being operable to store digital data interpretable by a processor to enable subsequent reprinting of the document.

9. An electronic device electrically couplable to a printer, computer or network, configured to couple with a portable solid state memory device and to receive data corresponding to a print job, and operable to write data to the said solid state memory device, substantially at the time of printing of the said print job, to enable subsequent reprinting of the print job.

10. An electronic device as claimed in claim 9 further configured to transfer a digital version of the content of the print job to the said solid state memory device.

11. An electronic device as claimed in claim 10 wherein the format of the digital version of the content of the print job is selected from a group comprising: the native file format of the content of the print job; Printer Control Language; Postscript format; hypertext markup language; Portable Document Format.

12. An electronic device as claimed in claim 9 further configured to transfer to the said solid state memory device a link to a digital version of the content of the print job.

13. An electronic device as claimed in claim 9 further operable to read data from a portable solid state memory device and enable the printing of a document specified by the said data.

14. An electronic device as claimed in claim 9 integral with a printer.

15. An electronic device as claimed in claim 9 having a carousel capable of holding a plurality of portable solid state memory devices and operable to write to each of the said memory devices in sequence.

16. An electronic device as claimed in claim 9 further configured to erase or re-use a portable solid state memory device to which data corresponding to a print job has been transferred but which has not been removed from the electronic device within a predetermined time period.
